(19) United States
(12) Patent Application Publication
(10) Pub. No.: US 2013/0015947 A1
(43) Pub. Date: Jan. 17, 2013

(54) METHOD AND SYSTEM FOR ACCESS AUTHORIZATION

(71) Applicant: Manfred Best, Buchholz (DE)

(72) Inventor: Manfred Best, Buchholz (DE)

(73) Assignee: TELEKOM DEUTSCHLAND GmbH, Bonn (DE)

(21) Appl. No.: 13/520,582

(22) PCT Filed: Dec. 29, 2010
(86) PCT No.: PCT/EP2010/007958

§ 371 Date: Oct. 2, 2012

Related U.S. Application Data
(60) Provisional application No. 61/293,242, filed on Jan. 8, 2010.

(30) Foreign Application Priority Data
Jan. 8, 2010 (EP) 10000100.7

(51) Int. Cl. G06F 7/04

(52) U.S. Cl. 340/5.7

(57) ABSTRACT

A method for access authorization includes: generating, by a mobile terminal, first location data in relation to the location of the mobile terminal; comparing the first location data with stored second location data and determining that the first location data matches the second location data; establishing, by the mobile terminal, a first connection to an authorization client using a mobile communication network comprising a base station; sending, by the mobile terminal, identification data to the authorization client to request access authorization; establishing, by a detection client, a second connection to the mobile terminal, wherein the second connection is a direct packet switched connection; and granting access to a user of the mobile terminal when a position of the user relative to the detection client matches a predefined position relative to the detection client.

### CROSS-REFERENCE TO RELATED APPLICATIONS

This patent application is a national stage entry under 35 U.S.C. §371 of International Application No. PCT/EP2010/007958, filed Dec. 29, 2010, and claims priority to European Patent Application No. EP 10000100.7, filed Jan. 8, 2010, and U.S. Provisional Patent Application No. 61/293,242, filed Jan. 8, 2010. The International Application was published in English on Jul. 14, 2011, as WO 2011/082818 A1.

### FIELD

The present invention relates to a method, a system, a program and a computer program product for access authorization, especially for a fast and comfortable access, for example at an entrance of a company building or other access restricted locations.

### BACKGROUND

An access control system for doors is known from German publication DE 102 46 663 A1, which discloses an access control system comprising various plug-in exchangeable modules. The individual modules are connected over a data line and/or bus system and/or a radio transceiver with a central computer. Identification of an authorized person is achieved using a mobile phone. To increase security, the access and authorization data are transmitted in different manners over the data line and bus systems to two different computers. According to a preferred embodiment of the known system, the mobile phone contacts the system automatically in case the mobile phone approaches the access controlled area.

The drawback of the system and the method mentioned above is that there is no possibility to accurately detect the location of the person and thereby to assure that the door opens for the authorized person only and not for an unauthorized person who is located, for example, in front of the authorized person.

### SUMMARY

In an embodiment, the present invention provides a method for access authorization. The method includes: generating, by a mobile terminal, first location data in relation to the location of the mobile terminal; comparing the first location data with stored second location data and determining that the first location data matches the second location data; establishing, by the mobile terminal, a first connection to an authorization client using a mobile communication network comprising a base station; sending, by the mobile terminal, identification data to the authorization client to request access authorization; establishing, by a detection client, a second connection to the mobile terminal; and granting access to a user of the mobile terminal when a position of the user relative to the detection client matches a predefined position relative to the detection client. The second connection is a direct packet switched connection. The predefined position is a specific area relative to a gate. The gate opens automatically if the user is authorized and the position of the user relative to the detection client matches a predefined position relative to the detection client.

### BRIEF DESCRIPTION OF THE DRAWINGS

FIG. 1 shows schematically a configuration of a system for access authorization according to the present invention.

FIG. 2 shows schematically a first connection between a mobile terminal and an authorization client.

FIG. 3 shows schematically an exchange of information between the mobile terminal and the authorization client.

FIG. 4 shows schematically a second connection between the mobile terminal and a detection client.

FIG. 5 shows schematically an exchange of information between the mobile terminal and the detection client.

FIG. 6 shows schematically an example of the configuration of signals exchanged for the access authorization.

### DETAILED DESCRIPTION

Embodiments of the present invention provide a method, a system, a program and a computer program device for access authorization, especially for a fast and comfortable access, for example at an entrance of a company building or other access restricted locations, the method providing a security level at least comparable to a conventional system, wherein a use of the system is more comfortably for a user and/or an entry to the access restricted location works faster.

In an embodiment, the present invention providesa method for access authorization, the method comprising a first step and a second step, wherein the first step comprises a mobile terminal generating a first location data in relation to its location and comparing the first location data with stored second location data, wherein in case that the first location data matches the second location data, the mobile terminal establishes a first connection to an authorization client using a mobile communication network comprising a base station, wherein the mobile terminal sends a second identification data to the authorization client, to request the authorization client for access authorization, wherein the second step comprises a detection client establishing a second connection to the mobile terminal, wherein the second connection is a direct packet switched connection and wherein the second step comprises granting access to the mobile terminal and its user and/or to a user's vehicle, in case a first position of the user of the mobile terminal, or the user's vehicle relative to the detection client matches a predefined second position relative to the detection client, wherein the predefined second position is a specific area relative to a gate, wherein the gate opens automatically if the user of the mobile terminal, or the user's vehicle is authorized and if its first position matches the second position.

According to the present invention, it is thereby advantageously possible to accurately detect the position of the user of the mobile terminal and/or the user's vehicle, by the detection client. By way of example, the detection client verifies that the user is located in front of a gate or in a specific area relative to the gate. In the context of the present invention, the “gate” is any point of access (as a door, a gate or another means allowing to restrict the access of a person or a vehicle to a specified area in a first mode of operation (“door/gate closed”) and permitting the access of a person or a vehicle to the specified area in a second mode of operation (“door/gate open”). In the present example, the detection procedure assures that the gate opens for the authorized user of the mobile terminal and/or the user's vehicle only and not for an unauthorized vehicle in front of the authorized user's vehicle, for instance. Thereby, on the one hand the safety level of the system can be increased in contrast to systems of the prior art, on the other hand the use of the system according to the invention is more comfortable for the user and/or the entry to the access restricted location works faster than the systems of the prior art.

According to a preferred embodiment of the present invention, the mobile terminal comprises a GPS receiver, in order to detect its location and to generate the first location data, wherein a transmission of the second identification data to the authorization client takes place automatically. Advantageously, the user of the mobile terminal does not have to operate the mobile terminal to call the authorization client or to send the second identification data to the authorization client.

According to another preferred embodiment of the present invention, a positioning signal is transmitted repeatedly between the detection client and the mobile terminal using the second connection, the positioning signal being preferably sent every at least 1 to 5 seconds and the repeated positioning signals having preferably an equal signal strength. An advantage thereof is that it is possible to locate the user of the mobile terminal and/or the user's vehicle in relation to the detection client more precisely and/or more quickly than the systems from the prior art can.

According to another preferred embodiment of the present invention, the detection client comprises a processing unit, a first antenna and a second antenna, wherein the first antenna receives the positioning signal over the second connection in a first signal strength and wherein the second antenna receives the positioning signal of the second connection in a second signal strength, wherein the first signal strength and the second signal strength are evaluated by using the processing unit in order to detect the first position of the user of the mobile terminal and/or the user's vehicle relative to the detection client. An advantage thereof is that an accuracy of a detection procedure can be increased compared to a usage of a single antenna. Furthermore, a determination whether the user of the mobile terminal and/or the user's vehicle is located between the first antenna and the second antenna or not, can be provided.

According to another preferred embodiment of the present invention, the predefined second position is provided such that it comprises preferably about 4 to 8 square meters, wherein the predefined second position is preferably located directly in front of the gate, and corresponding preferably to a first place in a queue of vehicles. An advantage thereof is that on the one hand a check-in especially of vehicles is accomplished comparatively fast but on the other hand the safety level persists on a comparatively high level, because the gate opens for the authorized users of the mobile terminal and/or the user's vehicle only.

According to another preferred embodiment of the present invention, an alternative access authorization is possible if the mobile terminal is not usable, preferable the entry with a company-card. An advantage thereof is that it is possible to get authorized by using the company-card if the mobile terminal is not usable, e.g. if a battery is running out of power and/or the mobile terminal is forgotten at home. In this case the gate opens if an authorization procedure is performed successfully.

According to another preferred embodiment of the present invention, a time period of access authorization is configurable in an arbitrary manner, wherein a first time period is a time of usual access and for example a second time period is a time period of access denial, wherein a different safety standard applies in the first time period and in the second time period, wherein the access authorization can require an additional keyword during the second time period, wherein particularly the second time period can be the time of a weekend, a holiday or a night. An advantage thereof is that the safety level can be enhanced by a configuration of the first time period and any other configurable time periods. The shorter first time period results in a higher safety level. Furthermore an advantage thereof is that, a night-watchman or a security agency is able to enter using the additional keyword during the second time period, for instance

According to another preferred embodiment of the present invention, a database is assigned to the authorization client, wherein a first identification data is stored at the database, wherein the authorization client compares a transmitted second identification data from the mobile terminal with the first identification data of the database, to check the access authorization. An advantage thereof is that the first identification data can be updated automatically if the access should be granted to new employees, further there can be defined different authorization conditions for every employee or for certain groups.

In another embodiment, the present invention provides a system comprising the authorization client, the detection client and the mobile terminal, wherein the authorization client comprises a first radio interface, which is configurable for establishing the first connection with the mobile terminal by using the base station of the mobile communication network, wherein the authorization client further comprises a first element which is configurable for granting the access authorization, wherein the detection client comprises a first radio device, which is configurable for establishing the packet switched second connection with the mobile terminal, wherein the detection client is configurable for the detection of the first position of the user of the mobile terminal or the user's vehicle relative to the detection client, by means of the first radio device establishing the direct packet switched connection to the mobile terminal, wherein the mobile terminal comprises a second element, which is configurable for the detection of its location and for generating the first location data relating to the first location, the mobile terminal further comprises the stored second location data, wherein the system is configured for granting access to the mobile terminal and its user and/or to a user's vehicle, in case the first position of the user of the mobile terminal, or the user's vehicle relative to the detection client matches a predefined second position relative to the detection client, wherein the predefined second position is a specific area relative to a gate, wherein the gate opens automatically if the user of the mobile terminal, or the user's vehicle is authorized and if its first position matches the second position.

According to a preferred embodiment of the present invention, the database is assigned to the authorization client, wherein the database contains the first identification data for the access authorization. An advantage thereof is that the database is capable of comprising a plurality of further data of the employee beside the first identification data, for example a registered holiday, a personal shift schedule, an associated group of employees and all doors or gates the employee is authorized to enter.

According to another preferred embodiment of the present invention, the second connection between the mobile terminal and the detection client is realized as a Bluetooth connection or a W-LAN connection, wherein the first radio device of the detection client is designed preferably for establishing the Bluetooth connection or the W-LAN connection, wherein the mobile terminal comprises a second radio device, which is configured for communication by the packet switched connection, particularly by Bluetooth or by W-LAN. An advantage thereof is that the second connection is capable of passing e.g. cloths, briefcases and vehicle body structures. In particular, an optional line of sight is not necessary. A further advantage thereof is that a plurality of components can be connected simultaneously.

According to another preferred embodiment of the present invention, the detection client comprises the processing unit, the first antenna and the second antenna, wherein the processing unit is configurable for evaluation of the signal strengths, wherein the first antenna is located directly at the gate and the second antenna is located in a configurable distance from the gate. An advantage thereof is that the predefined second position is located between the first antenna and the second antenna, so that the first position matches the second position, if the user of the mobile terminal and/or the user's vehicle is located directly in front of the gate.

According to another preferred embodiment of the present invention, the stored second location data specify a position of the company buildings with access authorization, particularly office buildings, production halls or car parks. An advantage thereof is that the mobile terminal is capable of detecting a vicinity of a stored building, so that the mobile terminal contacts the authorization client automatically. A further advantage is that the system according to the invention is applicable not only at car parks but also at other buildings of the company like the office buildings, the production halls, or the like.

In another embodiment, the present invention provides a program comprising a computer readable program code for controlling the access authorization using the first connection between the mobile terminal and the authorization client and using the second connection between the mobile terminal and the detection client, wherein the first connection uses the mobile communication network comprising the base station, wherein the mobile terminal detects its location and generates the relating first location data, wherein the authorization client is contacted by the mobile terminal if the first location data matches the stored second location data, wherein the second identification data is sent to the authorization client to request the authorization client for access authorization, wherein the second connection uses the packet switched connection, wherein the first position of the user of the mobile terminal or the user's vehicle is detected by the detection client by means of the second connection, wherein the access is granted, if the first position matches the predefined second position relative to the detection client, wherein the predefined second position is a specific area relative to a gate, wherein the gate opens automatically if the user of the mobile terminal, or the user's vehicle is authorized and if its first position matches the second position.

In another embodiment, the present invention provides a computer program product comprising the computer readable program code for controlling the access authorization. An advantage thereof is that the program can be installed not only on the mobile terminal but also on a notebook, a personal digital assistant, a car computer, or the like. A further advantage is that a product can be developed especially for that program.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

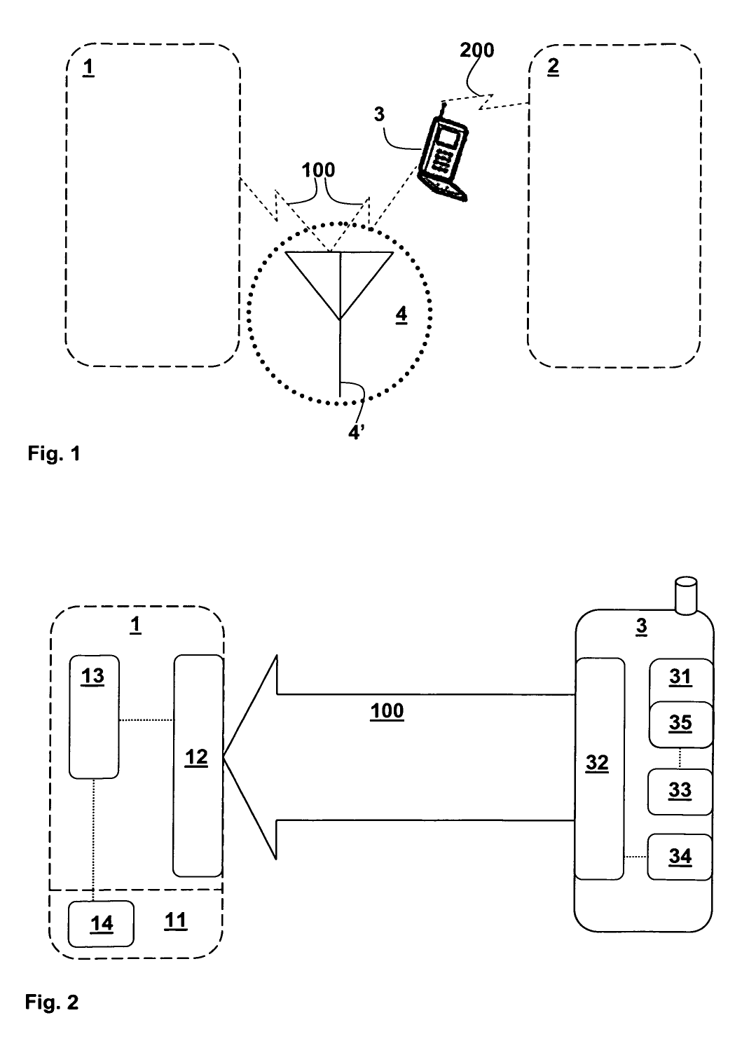

FIG. 1 shows schematically a configuration of a system for access authorization according to the present invention. The system comprises an authorization client 1, a detection client 2 and a mobile terminal 3. The mobile terminal 3 establishes a first connection 100 to the authorization client 1 by using a mobile communication network 4 with a base station 4′. Subsequently a second connection 200 between the mobile terminal 3 and the detection client 2 is established by using a packet switched connection. The system for access authorization according to the present invention can be used by a user of the mobile terminal 3 walking by foot or by the user of the mobile terminal 3 driving his vehicle.

FIG. 2 shows schematically the first connection 100 between the mobile terminal 3 and the authorization client 1. A database 11 where a first identification data 14 is stored is assigned to the authorization client 1. Furthermore the authorization client 1 comprises a first radio interface 12 which is configured for a communication with the mobile terminal 3 by using the mobile communication network 4 with the base station 4′. Hereinafter, the terms GPS (Global Positioning System) and GNSS (Global Navigation Satellite System) are used synonymously, i.e. in case GPS is mentioned also GNSS is meant and vice versa. The authorization client 1 further comprises a first element 13 which is configurable for granting the access authorization for the mobile terminal 3. The mobile terminal 3 comprises a second element 31, which is designed as a GPS receiver and a second radio interface 32 which is configured for a communication with the authorization client 1 by using the mobile communication network 4 with the base station 4′. Furthermore the mobile terminal 3 comprises a stored second location data 33 and a second identification data 34. After the second element 31 of the mobile phone 3 has generated a first location data 35 relating to its location the mobile terminal 3 compares the first location data 35 with the stored second location data 33 continuously, preferably regularly, e.g. once a second. The mobile terminal 3 contacts the authorization client 1 automatically, by using the first connection 100 if the first location data 35 matches the second location data 33, wherein matches means that the mobile terminal 3 is located in the vicinity of a company building or a specific point thereof, e.g. an entrance, e.g. within about 250 m around the company building or about 50 m around the company building. Subsequently the mobile terminal 3 sends the second identification data 34 to the authorization client 1. After the first radio interface 12 of the authorization client 1 has received the second identification data 34 from the mobile terminal 3, the second identification data 34 is compared with the first identification data 14. If the second identification data 34 matches the first identification data 14, the user of the mobile terminal 3 and/or the user's vehicle get authorized, wherein matches means that the first identification data 14 is exactly the same than the second identification data 34.

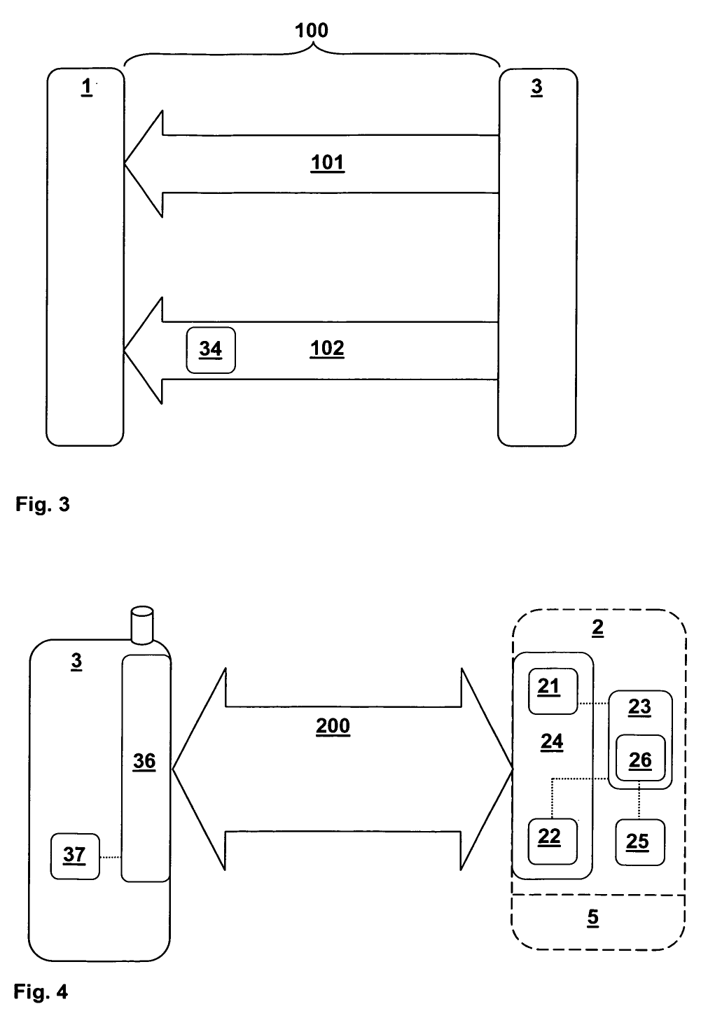

FIG. 3 shows schematically an exchange of information between the mobile terminal 3 and the authorization client 1 using the first connection 100. In a third step 101 the mobile terminal 3 contacts the authorization client 1 automatically, if the first location data 35 matches the second location data 33. Subsequently, the mobile terminal 3 sends in a fourth step 102 the second identification data 34 to the authorization client 1.

FIG. 4 shows schematically the second connection 200 between the mobile terminal 3 and the detection client 2. The detection client 2 comprises a processing unit 23 and a first radio device 24 which is configured for the communication with the mobile terminal 3 over the second connection 200, wherein the second connection 200 is the packet switched connection, preferably a short range connection over a distance of less than 50 m or less than 20 m or less than 10 m. A gate 5 or other access restriction means is assigned to the detection client 2. According to an exemplary embodiment of the present invention, the first radio device 24 comprises a first antenna 21 and a second antenna 22, wherein the first antenna 21 and the second antenna 22 are located in two different distances from the gate 5. The mobile terminal 3 comprises a second radio device 36 which is configured for a communication with the detection client 2 via the second connection 200. By using the first antenna 21 and the second antenna 22, a more accurate detection of a first position 26 of the user of the mobile terminal 3 and/or the user's vehicle relative to a second position 25 in front of the gate 5 is possible by establishing the second connection 200 between the detection client 2 and the mobile terminal 3. The signal strengths are evaluated by the processing unit 23 and the first position 26 of the user of the mobile terminal 3 and/or the user's vehicle is determined. If the measured first position 26 of the mobile terminal 3, matches the predefined second position 25 in front of the gate 5, the user of the mobile terminal 3 and/or the user's vehicle are authorized and the gate 5 opens automatically. According to alternative embodiments of the present invention, the second connection 200 is either established by the mobile terminal 3 or by the detection client 2. A positioning signal preferably with an equal signal strength, is transmitted between the detection client 2 and the mobile terminal 3 via the second connection 200. Via the second connection 200, the second radio device 36 of the mobile terminal 3 receives an information 37 from the detection client 2. For example the mobile terminal 3 receives a positioning signal from the detection client 2 and the answer signal comparing the information 37 permitting the identification of the mobile terminal 3. The answer signal is received by the first antenna 21 with a first signal strength and by the second antenna 22 with a second signal strength. It is e.g. possible to locate the mobile terminal 3 by means of the mobile terminal 3 is located between the first antenna 21 and the second antenna 22, the first received signal strength and the second received signal strength being nearly equal to each other.

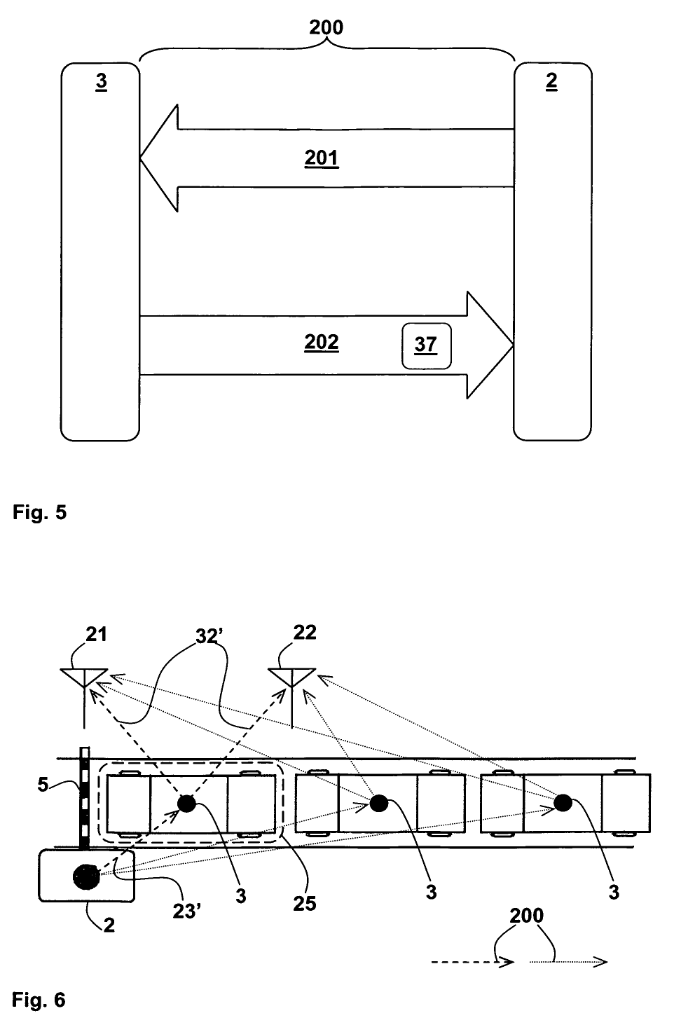

FIG. 5 shows schematically an exchange of information between the mobile terminal 3 and the detection client 2 over the second connection 200. In a fifth step 201 the detection client 2 sends the positioning signal, preferably with the equal signal strength, to the mobile terminal 3 over the second connection 200. The answer-signal, preferably with the equal signal strength, is sent back from the mobile terminal 3 to the detection client 2 over the second connection 200, in a sixth step 202. The answer-signal comprises the information 37 for the identification of the mobile terminal 3.

FIG. 6 shows schematically an example of a configuration of the positioning signals exchanged for the access authorization, between the mobile terminal 3 and the detection client 2. The gate 5 or a barrier 5 at an entrance of a car park or the company building is provided in order to maintain a certain safety level. In the present example a queue of cars is located in front of the barrier 5. The detection client 2 sends the positioning signal to all mobile terminals 3 in the range of the positioning signal over the second connection 200. All mobile terminals 3 that receive the positioning signal and are authorized to enter the gate 5, send the answer signal in conjunction with the information 37 for the identification of the mobile terminal 3 back to the detection client 2. The answer signals from the mobile terminals 3 are received by the first antenna 21 and the second antenna 22, each with different signal strength resulting from a different distance between the mobile terminals 3 and the two antennas 21, 22 respectively. The processing unit 23 of the detection client 2 evaluates the received signal strengths and determines the identity of the first car in front of the gate 5. E. g. if both signal strengths from one mobile terminal 3 have respectively a predefined signal strength, the first position 26 and the predefined second position 25 matches each other. Correspondingly, the user of the mobile terminal 3 and/or the user's vehicle being located directly in front of the barrier 5 becomes authorized so that the gate 5 opens automatically.

1-15. (canceled)

16. A method for access authorization, the method comprising:
generating, by a mobile terminal, first location data in relation to the location of the mobile terminal;
comparing the first location data with stored second location data and determining that the first location data matches the second location data;
establishing, by the mobile terminal, a first connection to an authorization client using a mobile communication network comprising a base station;
sending, by the mobile terminal, identification data to the authorization client to request access authorization;
establishing, by a detection client, a second connection to the mobile terminal, wherein the second connection is a direct packet switched connection; and
granting access to a user of the mobile terminal when a position of the user relative to the detection client matches a predefined position relative to the detection client, wherein the predefined position is a specific area relative to a gate, and wherein the gate opens automatically if the user is authorized and the position of the user relative to the detection client matches a predefined position relative to the detection client.

17. The method according to claim 16, wherein the mobile terminal comprises a GPS receiver configured to detect the location of the mobile terminal and to generate the first location data, and wherein a transmission of the identification data to the authorization client takes place automatically.

18. The method according to claim 16, wherein a positioning signal is transmitted repeatedly between the detection client and the mobile terminal using the second connection.

19. The method according to claim 18, wherein the positioning signal is sent every 1 to 5 seconds and the repeated positioning signals having substantially equal signal strength.

20. The method according to claim 18, wherein the detection client comprises a processing unit, a first antenna and a second antenna, wherein the first antenna receives the positioning signal over the second connection in a first signal strength and wherein the second antenna receives the positioning signal of the second connection in a second signal strength, wherein the first signal strength and the second signal strength are evaluated by using the processing unit in order to detect the position of the user relative to the detection client.

21. The method according to claim 16, wherein the predefined position comprises about 4 to 8 square meters.

22. The method according to claim 16, wherein the predefined second position is located directly in front of the gate and corresponds to a first place in a queue of vehicles.

23. The method according to claim 16, wherein alternative access authorization is further provided through use of a company-card.

24. The method according to claim 16, wherein access is granted according to different standards at different time periods.

25. The method according to claim 24, wherein during a particular time period, granting of access requires an additional keyword relative to another time period, wherein the particular period is a weekend, holiday, or nighttime.

26. The method according to claim 16, wherein a database is assigned to the authorization client, wherein the authorization client compares the identification data sent from the mobile terminal with identification data stored at the database to determine whether access is authorized.

27. A system for access authorization, wherein the system comprises:
an authorization client, comprising:
a first radio interface, configured to establish a first connection with a mobile terminal by using a base station of a mobile communication network; and
a first element configured to grant an access authorization;
a detection client, configured to detect a position of a user of the mobile terminal relative to the detection client using a first radio device configured to establish a packet switched second connection with the mobile terminal; and
the mobile terminal, comprising:
a second element, configured to detect the location of the mobile terminal and to generate first location data relating to the detected location of the mobile terminal;
second location data stored at the mobile terminal;
wherein access to a gate is granted to the user of the mobile terminal when the position of the user relative to the detection client matches a predefined position relative to the detection client, wherein the predefine position relative to the detection client is a specific area relative to the gate; and
wherein the gate opens automatically if the user is authorized and the position of the user relative to the detection client matches the predefined position relative to the detection client.

28. The system according to claim 27, further comprising a database assigned to the authorization client, wherein the database contains identification data for access authorization.

29. The system according to claim 27, wherein the second connection is a Bluetooth or W-LAN connection, and wherein the mobile terminal comprises a second radio device configured for communication by the second connection.

30. The system according to claim 27, wherein the detection client comprises a processing unit, a first antenna and a second antenna, wherein the processing unit is configured to evaluate signal strengths, wherein the first antenna is located directly at the gate, and the second antenna is located at a configurable distance from the gate.

31. The system according to claim 27 wherein the stored second location data specifies a position of company buildings with access authorization, wherein the company buildings are office buildings, production halls or car parks.

32. A non-transitory computer-readable medium having processor-executable instructions for access authorization stored thereon, the processor-executable instructions, when executed, causing the following steps to be performed:
generating, by a mobile terminal, first location data in relation to the location of the mobile terminal;
comparing the first location data with stored second location data and determining that the first location data matches the second location data;
establishing, by the mobile terminal, a first connection to an authorization client using a mobile communication network comprising a base station;
sending, by the mobile terminal, identification data to the authorization client to request access authorization;
establishing, by a detection client, a second connection to the mobile terminal, wherein the second connection is a direct packet switched connection; and
granting access to a user of the mobile terminal when a position of the user relative to the detection client matches a predefined position relative to the detection client, wherein the predefined position is a specific area relative to a gate, and wherein the gate opens automatically if the user is authorized and the position of the user relative to the detection client matches a predefined position relative to the detection client.
